(19) United States
(12) Patent Application Publication
(10) Pub. No.: US 2024/0365190 A1
(43) Pub. Date: Oct. 31, 2024

(54) CONTROL OF A HANDOVER IN A COMMUNICATION NETWORK

(71) Applicant: Nokia Technologies Oy, Espoo (FI)

(72) Inventors: Klaus Ingemann PEDERSEN, Aalborg (DK); Stefano PARIS, Massy (FR); Zexian LI, Espoo (FI)

(21) Appl. No.: 18/686,723

(22) PCT Filed: Sep. 16, 2021
(86) PCT No.: PCT/EP2021/075465

§ 371 Date: Feb. 26, 2024

(51) Int. Cl. H04W 36/08; H04W 36/18; H04W 36/30; H04W 76/20

(52) U.S. Cl. CPC H04W 36/08; H04W 36/18; H04W 36/30; H04W 76/20

(57) ABSTRACT

There is provided an apparatus for a network node comprising means for making a decision on a handover, HO, and means for determining a time raster indicating eligible time instants for HO messaging during a network communication. The eligible time instants are based on at least one of: a radio access network, RAN, traffic and a core network, CN. The apparatus further comprises means for sending a HO request message including the timer raster.

Various example embodiments relate to a method, an apparatus, a computer program product and computer executable instructions for controlling a handover (HO) in a communication network enabling periodic- or quasiperiodic traffic, for example extended reality (XR) implementation.

### BACKGROUND

Implementations, like extended reality (XR), give rise to considerations on network traffic towards high throughput, low latency and reliability. Extended reality (XR) refers to all real-and-virtual combined environments and associated human-machine interactions generated by computer technology and wearables. In fifth generation (5G) networks time-critical communications are an emerging concept for enabling services with reliable low latency requirements, such as XR. For XR applications, large amount of data on scene and 3-dimensional objects is exchanged. In order to enable sense of real or immersive environment, continuous, real time data exchange and updates are provided. The 5G radio access network (RAN), 5G core (5GC) and the transport network together with a device contribute to the end-to-end reliability and latency. End-to-end latency is the sum of individual latency contributions from every component. End-to-end reliability corresponds to reliability of the entire end-to-end link.

### SUMMARY

Interruptions caused by a handover (HO) are a concern for network services, including extended reality (XR) applications and performance. Controlling interruptions of a service during a handover enables to reduce or avoid packet or frame losses. This has positive effect on quality of service and performance.

According to some aspects, there is provided the subject-matter of the independent claims. Some example embodiments are defined in the dependent claims. The scope of protection sought for various example embodiments is set out by the independent claims. The example embodiments and features, if any, described in this specification that do not fall under the scope of the independent claims are to be interpreted as examples useful for understanding various example embodiments.

According to a first aspect, there is provided an apparatus for a network node, comprising means causing the apparatus to, or the apparatus configured to: make a decision on a handover, HO, determine a time raster indicating eligible time instants for HO messaging during a network communication, and send a HO request message including the time raster. The eligible time instants are based on at least one of: a radio access network, RAN, traffic and a core network, CN.

According to a second aspect, there is provided an apparatus for a network node, comprising means for causing the apparatus to, or the apparatus configured to: receive a handover, HO, request message including a time raster indicating eligible time instants for HO messaging during a network communication, wherein the eligible time instants are based on at least one of: a radio access network, RAN, traffic and a core network, CN; and configure random access, RA, resources for the HO based on the received time raster.

According to a third aspect, there is provided an apparatus for a mobile device, comprising means for causing the apparatus to, or configured to: receive a radio resource control, RRC, reconfiguration message including a time raster indicating eligible time instants for HO messaging during a network communication, wherein the eligible time instants are based on at least one of: a radio access network, RAN, traffic and a core network, CN; perform random access channel, RACH, procedure at one or more eligible time instants indicated in the time raster; and optionally send a RRC reconfiguration complete message at one or more eligible time instants indicated in the time raster.

According to a fourth aspect any of the apparatus of the first, second and the third aspect comprises at least one processor, and at least one memory including computer program code, that at least one memory and the computer program code configured to, with the at least one processor, cause the performance of the apparatus.

According to a fifth aspect, there is provided a method for a network node comprising making a decision on a handover, HO, determining a time raster indicating eligible time instants for HO messaging during a network communication, and sending a HO request message including the time raster. The eligible time instants are based on at least one of: a radio access network, RAN, traffic and a core network, CN.

According to sixth aspect, there is provided a method for a network node comprising receiving a handover, HO, request message including a time raster indicating eligible time instants for HO messaging during a network communication, wherein the eligible time instants are based on at least one of: a radio access network, RAN, traffic and a core network, CN; and configuring random access, RA, resources for the HO based on the received time raster.

According to seventh aspect, there is provided a method for a mobile device comprising receiving a radio resource control, RRC, reconfiguration message including a time raster indicating eligible time instants for HO messaging during a network communication, wherein the eligible time instants are based on at least one of: a radio access network, RAN, traffic and a core network, CN; performing random access channel, RACH, procedure at one or more eligible time instants indicated in the time raster; and optionally sending a RRC reconfiguration complete message at one or more eligible time instants indicated in the time raster.

According to eight aspect, there is provided a computer program configured to cause a method in accordance with any one of fifth, sixth and seventh aspects to be performed.

According to ninth aspect, there is provided a non-transitory computer readable medium comprising program instructions that, when executed by at least one processor, cause an apparatus at least: to make a decision on a handover, HO, to determine a time raster indicating eligible time instants for HO messaging during a network communication, and to send a HO request message including the time raster. The eligible time instants are based on at least one of: a radio access network, RAN, traffic and a core network, CN.

According to tenth aspect, there is provided a non-transitory computer readable medium comprising program instructions that, when executed by at least one processor, cause an apparatus at least: to receive a handover, HO, request message including a time raster indicating eligible time instants for HO messaging during a network communication, wherein the eligible time instants are based on at least one of: a radio access network, RAN, traffic and a core network, CN; and to configure random access, RA, resources for the HO based on the received time raster.

According to eleventh aspect, there is provided a non-transitory computer readable medium comprising program instructions that, when executed by at least one processor, cause an apparatus at least: to receive a radio resource control, RRC, reconfiguration message including a time raster indicating eligible time instants for HO messaging during a network communication, wherein the eligible time instants are based on at least one of: a radio access network, RAN, traffic and a core network, CN; to perform random access channel, RACH, procedure at one or more eligible time instants indicated in the time raster; and optionally to send a RRC reconfiguration complete message at one or more eligible time instants indicated in the time raster.

### BRIEF DESCRIPTION OF THE DRAWINGS

FIG. 1 shows, by way of example, a network architecture of a communication system;

FIG. 2a shows, by way of example, a part of a radio access network system;

FIG. 2b shows, by way of example, signalling during handover procedure;

FIG. 3 shows, by way of example, a block diagram of an apparatus;

FIG. 4a shows, by way of example, a time raster implementation;

FIG. 4b shows, by way of example, a time raster implementation;

FIG. 5a shows, by way of example, a flow chart of a method for a network node;

FIG. 5b shows, by way of example, a flow chart of a method for a network node; and

FIG. 5c shows, by way of example, a flow chart of a method for a mobile device.

### DETAILED DESCRIPTION

In Dual Active Protocol Stack (DAPS) handover (HO) a mobile device is configured to receive data simultaneously from both a source cell and a target cell of a communication network during the HO. In order to reduce or avoid interruption of critical traffic, like extended reality (XR) payload transmission and reception, a time raster indicating eligible transmission and reception times is introduced. The source cell determines the time raster and communicates the time raster information to the target cell and to the mobile device. The time raster enables implementation of downlink and uplink communication at the eligible times, without disturbances or harming network quality or service performance during a HO.

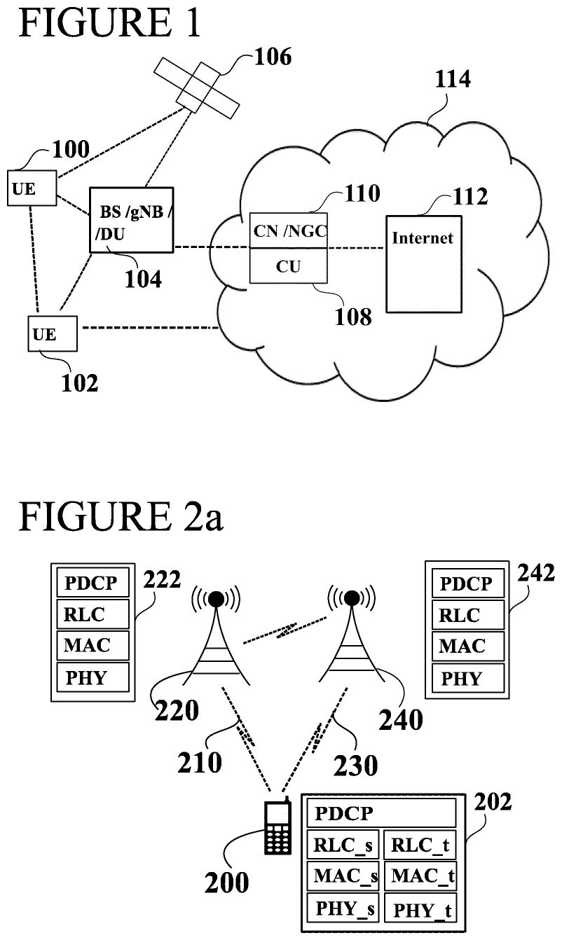

FIG. 1 shows, by way of an example, a network architecture of communication system. In the following, different exemplifying embodiments will be described using, as an example of an access architecture to which the embodiments may be applied, a radio access architecture based on long term evolution advanced (LTE Advanced, LTE-A) or new radio (NR), also known as fifth generation (5G), without restricting the embodiments to such an architecture, however. It is obvious for a person skilled in the art that the embodiments may also be applied to other kinds of communications networks having suitable means by adjusting parameters and procedures appropriately. Some examples of other options for suitable systems are long term evolution (LTE, the same as E-UTRA), wideband code division multiple access (WCDMA) or any combination thereof.

The example of FIG. 1 shows a part of an exemplifying radio access network. FIG. 1 shows user devices 100 and 102 configured to be in a wireless connection on one or more communication channels in a cell with an access node, such as gNB, i.e. next generation NodeB, or eNB, i.e. evolved NodeB (eNodeB), 104 providing the cell. The physical link from a user device to the network node is called uplink (UL) or reverse link and the physical link from the network node to the user device is called downlink (DL) or forward link. It should be appreciated that network nodes or their functionalities may be implemented by using any node, host, server or access point etc. entity suitable for such a usage. A communications system typically comprises more than one network node in which case the network nodes may also be configured to communicate with one another over links, wired or wireless, designed for the purpose. These links may be used for signalling purposes. The network node is a computing device configured to control the radio resources of the communication system it is coupled to. The network node may also be referred to as a base station (BS), an access point or any other type of interfacing device including a relay station capable of operating in a wireless environment. The network node includes or is coupled to transceivers. From the transceivers of the network node, a connection is provided to an antenna unit that establishes bi-directional radio links to user devices. The antenna unit may comprise a plurality of antennas or antenna elements. The network node is further connected to core network 110 (CN or next generation core NGC). Depending on the system, the counterpart on the CN side can be a serving gateway (S-GW, routing and forwarding user data packets), packet data network gateway (P-GW), for providing connectivity of user devices (UEs) to external packet data networks, or mobile management entity (MME), etc. An example of the network node configured to operate as a relay station is integrated access and backhaul node (IAB). The distributed unit (DU) part of the IAB node performs BS functionalities of the IAB node, while the backhaul connection is carried out by the mobile termination (MT) part of the IAB node. UE functionalities may be carried out by IAB MT, and BS functionalities may be carried out by IAB DU. Network architecture may comprise a parent node, i.e. IAB donor, which may have wired connection with the CN, and wireless connection with the IAB MT.

The user device, or user equipment UE, typically refers to a portable computing device that includes wireless mobile communication devices operating with or without a subscriber identification module (SIM), including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. It should be appreciated that a user device may also be a nearly exclusive uplink only device, of which an example is a camera or video camera loading images or video clips to a network. A user device may also be a device having capability to operate in Internet of Things (IoT) network which is a scenario in which objects are provided with the ability to transfer data over a network without requiring human-to-human or human-to-computer interaction.

Additionally, although the apparatuses have been depicted as single entities, different units, processors and/or memory units may be implemented inside these apparatuses, to enable the functioning thereof.

5G enables using multiple input-multiple output (MIMO) technology at both UE and gNB side, many more base stations or nodes than the LTE (a so-called small cell concept), including macro sites operating in co-operation with smaller stations and employing a variety of radio technologies depending on service needs, use cases and/or spectrum available. 5G mobile communications supports a wide range of use cases and related applications including video streaming, virtual reality, extended reality, augmented reality, different ways of data sharing and various forms of machine type applications (such as (massive) machine-type communications (mMTC), including vehicular safety, different sensors and real-time control. 5G is expected to have multiple radio interfaces, namely below 7 GHz, cmWave and mmWave, and also being integratable with existing legacy radio access technologies, such as the LTE. Below 7 GHz frequency range may be called as FR1, and above 24 GHz (or more exactly 24-52.6 GHZ) as FR2, respectively. Integration with the LTE may be implemented, at least in the early phase, as a system, where macro coverage is provided by the LTE and 5G radio interface access comes from small cells by aggregation to the LTE. In other words, 5G is planned to support both inter-RAT operability (such as LTE-5G) and inter-RI operability (inter-radio interface operability, such as below 7 GHz-cm Wave, below 7 GHZ-cmWave-mmWave). One of the concepts considered to be used in 5G networks is network slicing in which multiple independent and dedicated virtual sub-networks (network instances) may be created within the same infrastructure to run services that have different requirements on latency, reliability, throughput and mobility.

The communication system is also able to communicate with other networks, such as a public switched telephone network (PSTN) or the Internet 112, or utilize services provided by them, for example via a server. The communication network may also be able to support the usage of cloud services, for example at least part of core network operations may be carried out as a cloud service (this is depicted in FIG. 1 by “cloud” 114). The communication system may also comprise a central control entity, or a like, providing facilities for networks of different operators to cooperate for example in spectrum sharing.

Edge cloud may be brought into radio access network (RAN) by utilizing network function virtualization (NFV) and software defined networking (SDN). Using edge cloud may mean access node operations to be carried out, at least partly, in a server, host or node operationally coupled to a remote radio head or base station comprising radio parts. It is also possible that node operations will be distributed among a plurality of servers, nodes or hosts. Application of cloud RAN architecture enables RAN real time functions being carried out at the RAN side (in a distributed unit, DU 104) and non-real time functions being carried out in a centralized manner (in a centralized unit, CU 108).

5G may also utilize satellite communication to enhance or complement the coverage of 5G service, for example by providing backhauling. Possible use cases are providing service continuity for machine-to-machine (M2M) or Internet of Things (IoT) devices or for passengers on board of vehicles, or ensuring service availability for critical communications, and future railway/maritime/aeronautical communications. Satellite communication may utilise geostationary earth orbit (GEO) satellite systems, but also low earth orbit (LEO) satellite systems, in particular mega-constellations (systems in which hundreds of (nano) satellites are deployed). Each satellite 106 in the constellation may cover several satellite-enabled network entities that create on-ground cells. The on-ground cells may be created through an on-ground relay node 104 or by a gNB located on-ground or in a satellite.

Extended reality (XR) is described in 3GPP TR 26.928, TR 22.842, TR 38.838. The extended reality (XR) refers to all variations of real-and-virtual combined embodiments and associated human-machine interactions generated by computer technology and wearables. Different types of realities and use cases may include virtual reality (VR), augmented reality (AR), added reality, mixed reality (MR), cloud gaming, sensory substitution, remote control and other. XR applications are dependent on device and network performance. Delays and lags have effect on sensed XR performance and quality of service (QOS). Interruption of XR performance may be due to handover (HO), which is subject to temporary service interruption times. Quality of Service (QOS) in 5G is enforced at the QoS flow level. There are several standardized 5G QoS identifier (5QI) values, which are mapped to QoS characteristics, like a packet delay budget and a packet error rate. A packet delay budget (PDB) may vary from 10 ms to 15 ms. An application layer packet error rate (PER), which includes errors due to packets received beyond PDB, is limited to 1%. Some HO interruption times are captured in 3GPP TS 38.133. Use of a dual active protocol stack (DAPS) may offer reduced interruption times, down to 2 ms. However, other sources of delays may be present or delays may be different for UL and DL. For example, an end-to-end delay for UL may be caused by a target cell being unable to forward buffered UL packets to user plane function (UPF)/serving gateway before it receives the final sequence number (SN) status transfer message. In practice, experienced interruption times for DAPS implementations may be in order of 4-10 ms. For UL, overall interruption may be around 15-20 ms. Delays and interruption times are a concern for XR applications. For example, HO duration may be longer than the PDB. In addition, timing of occurrence of interruption times during a HO is uncertain. Controlling interruption times enables reducing or avoiding risk of colliding with the time periods, where time critical XR payloads are transmitted. It is provided a DAPS HO, where interruption times for DL and UL data radio bearers (DRBs) are timed and controlled. Controlling HO occurrence and duration enables interruptions to be placed in between transmission or reception of time-critical XR payloads. This enables improved reliability to XR services, based on QoS constraints, and thereby enhanced user experience.

Throughout this application XR is discussed in more detail in order to illustrate periodic network traffic. However, an introduced time raster and utilization of such is applicable similarly to any network communications, implementations or services, using periodic- or quasiperiodic network traffic. For example, IoT implementations may benefit or be enabled due to provided reliability and low latency.

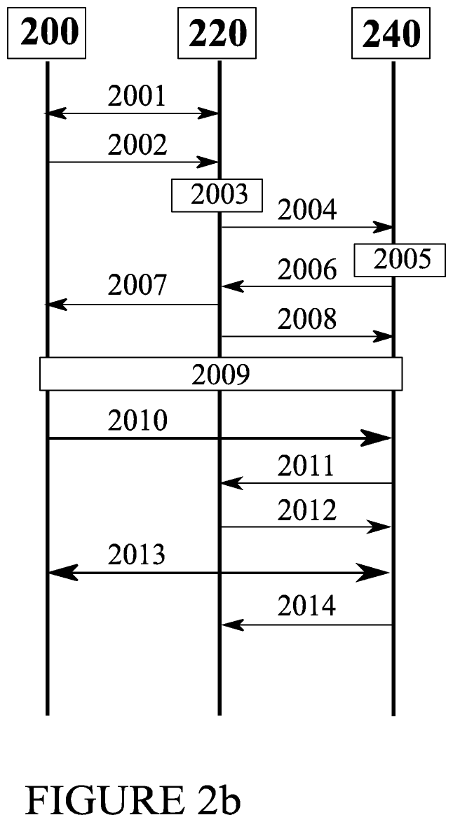

FIG. 2a shows, by way of example, a part of a radio access network system. The RAN of FIG. 2a is capable of performing a handover of a mobile device 200 between cells. A mobile device is connected to a cell of a radio network via a network node or an access node of the cell. A mobile device 200 may release the connection 210 from a source network node 220 of a source cell, before a connection 230 is established with a target network node 240 of a target cell. However, such hard handover causes an interruption in the communication. The interruption may be in order of a few tens of milliseconds. In order to avoid such interruption, the mobile device 200 connection 210 to the source cell may be maintained active, being enabled to receive and transmit data, until the mobile device 200 has established a connection 230 to the target cell, and ready to send and receive data under coverage of the target cell. The network nodes 220, 240 may communicate with one another, for example via signaling. The mobile device 200 is enabled to simultaneously receive and transmit data at both the source network node 220, and the target network node 240. This is enabled for a short time during the handover (HO) procedure. This is enabled by a dual active protocol stack (DAPS) 202. The mobile device 200 is configured to maintain DAPS 202 in an active state. The DAPS 202 includes two corresponding user plane protocol stacks: one for the target network node and a second for the source network node.

The mobile device 200 is configured to maintain a user plane dual active protocol stack 202 and the network nodes 220, 240 are configured to maintain corresponding radio protocol stacks 222, 242. The protocol stacks comprise similar layers. The higher protocol layers of the protocol stacks are based on LTE, and the IP header is replaced with a 5G equivalent at a packet data convergence protocol (PDCP) layer. A radio link control (RLC) layer is configured to organize the data and retransmission, if necessary. A medium access control (MAC) layer is configured to handle prioritization and hybrid automated retransmission requests. A physical (PHY) layer is configured to handle communication between the mobile device 200 and the core network. Data flows between the RLC, MAC and PHY layers of the protocol stack through channels. Logical channels between RLC and MAC layers define the type of data that can be transferred. Transport channels carry information from the MAC layer to the PHY layer. These channels define how the information will be carried to the physical layer and the characteristics of the data. The physical layer communicates directly with the mobile device or a user equipment through physical channels. Physical channel characteristics include timing, access, protocols and data rates.

The mobile device 200 of FIG. 2a is configured to maintain DAPS 202, which includes a physical layer (PHY), a medium access control (MAC) layer and a radio link control (RLC) layer for the source cell, provided by the source network node 220, and for the target cell, provided by the target network node 240. The mobile device 200 is configured to continue the downlink (DL) user data reception from the source cell network node 220 until releasing the source cell, and the mobile device 200 is configured to continue the uplink (UL) user data transmission to the source cell network node 220 until successfully completing random access procedure to the target cell network node 240. This enables the mobile device 200 to communicate simultaneously with both the source network node 220 and the target network node 240. A packet data convergence protocol (PDCP) layer 202 at the user plane is reconfigured to a common PDCP entity for the source and target network nodes 220, 240. A PDCP sequence number (SN) continuation is maintained throughout the handover procedure. This enables securing in-sequence delivery of data. A common re-ordering and duplication function may be provided in the single PDCP entity, where the single PDCP entity is common for the source and target cells.

The source network node 220 is configured to prepare a time raster comprising indication of eligible transmission times during HO. The source network node 220 is configured to determine eligible transmission times based on network quality indications and/or monitored communication traffic. The source network node 220 is configured to transmit the time raster to the target network node 240 and to the mobile device 200. The target network node 240 is configured to adjust radio access for the mobile device 200 based on the received time raster. The source network node 220, the target network node 240 and the mobile device 200 are configured to use the eligible transmission times indicated in the time raster during a handover. HO messages over the radio interface (Uu) are transmitted at the eligible transmission time instants. HO messages between the network nodes include information on the time instants of triggering and completing the HO procedure. The target network node is informed of the time instant(s) at which HO was triggered by the source network node, and the source network node is informed of the time instants(s) at which HO was completed according to RRC configuration complete message sent by the mobile device.

The introduced time raster enables controlling interruption time for DL and UL DRBs during a HO, which may employ a DAPS. Risk of colliding with the time periods, where critical XR payloads are transmitted, is reduced or even avoided. The DAPS HO, as presented, comprises controlling and accurately timing interruption times for DL and UL DRBs so that the HO messaging is set in between transmission/reception of time-critical payloads. Critical time instants may be based on RAN traffic or CN traffic.

FIG. 2b shows, by way of example, signalling during handover procedure. On the vertical axes are arranged, on the left, a mobile device 200 of FIG. 2a, on the middle a source network node 220 of a source cell of FIG. 2a, and on the right, a target network node 240 of a target cell of FIG. 2a. Time advances from the top toward the bottom. The mobile device 200 is configured to manage a DAPS during HO from the source cell to the target cell.

At phase 2001, the mobile device 200 is in a wireless connection on one or more communication channels in a cell with the source network node 220. The wireless connection may comprise UL, a physical link from the mobile device 200 to the source network node 220, and DL, a physical link from the source network node 220 to the mobile device 200. DL and UL user data may be communicated between the mobile device 200 and the source network node 220.

During the phase when a mobile device is attaching to a network node, after a radio bearer has been set up, the network node is configured to deliver measurement configurations, which may be based on the mobility trigger and policy settings, to the mobile device. The measurement configuration may be included in a radio resource control, RRC, reconfiguration message or in a RRC resume message. The network is able to update the measurement configuration for a mobile device while the mobile device is in a connected mode, resuming from inactive mode to connected mode, or provide a new measurement configuration in a handover command. A mobile device may report signal quality of the current serving cell and neighbour cell(s), among other measures. There are multiple measurement items and multiple ways to measure signal quality of the serving cell and neighbour cells. The mobile device is configured to keep on measurement of the serving cell and neighbour cell(s), report quantity and validate it with a threshold or offset defined in the measurement report configuration.

The source network node 220 is configured to monitor traffic and payload at the RAN. The source network node 220 is configured to determine desirable interruption times. Determination may be based on monitoring of UL and DL XR traffic and taking into account 5G quality of service identifier (5GQI). In addition, or alternatively, determination may be based on the information received from the 5G core network. Determination may comprise identification of time-critical XR payloads. The source network node 220 is configured to determine times or time windows for prioritising critical UL and DL traffic payloads. Tolerated messaging times are identified between those. This enables minimizing impact of HO to the QoS.

At phase 2002, the mobile device 200 is configured to send a measurement report to the source network node 220. The source network node 220 configures measurement procedures of the mobile device 200. The mobile device 200 is configured to report the measurement report according to measurement configuration (Meas Config).

At phase 2003, the source network node 220 is configured to make a HO decision. The decision, whether to trigger a handover or not, is taken by the source network node 220 based, at least partly, on the measurement report received from the mobile device 200. The decision on HO may be based on measurement report and radio resource management (RRM) information. After a decision to handover the mobile device 200, signalling continues according to phase 2004.

With the decision to handover the mobile device 200, the source network node 220 is configured to determine a time raster, which includes eligible times for DL and UL DRB switching. Eligible times represent feasible or preferred or recommend times or time-intervals for DL and UL bearer interruptions. This enables to reduce or avoid interruption of communication frames. This enables control over at least critical payload transmission and reception.

A phase 2004, a handover request message is sent to a target network node 240 of a target cell. The source network node 220 is configured to initiate HO procedure by sending the HO request message to the target network node 240. The source network node 220 is configured to issue a handover request message to the target network node 240. The handover request message may include a transparent RRC container with information for preparing the handover at the target network node 240. The HO request message comprises the time raster information. The time raster information may be embedded as one or more new information element(s) in the HO request message.

A phase 2005, the target network node 240 is configured to process the HO request. The target network node 240 is configured to adjust its random access (RA) resources for the mobile device 200 according to the received time raster. The target network node 240 is configured to prepare the handover.

At phase 2006, the target network node 240 is configured to send a handover request acknowledge message to the source network node 220. The handover request acknowledge message includes a transparent container, which is to be sent to the mobile device 200 via an RRC message in order to perform the handover. The target network node 240 is configured to indicate if a DAPS handover is accepted. The HO request acknowledge message comprises information on the RA resources for the mobile device 200 to use for the HO. The RA resources are adjusted by the target network node 240 based on the time raster.

At phase 2007, the source network node 220 is configured to trigger the handover. The source network node 220 is configured to send a RRC reconfiguration message to the mobile device 200. The RRC reconfiguration message includes the time raster.

At phase 2008, the source network node 220 is configured to send an early status transfer message to the target network node 240. Data radio bearers (DRBs) define packet treatment on the radio interface (Uu). The early status transfer message is used for DRBs, which are configured with DAPS.

The source network node 220 is configured to send with the early status transfer message, information on a DL count value, which indicates PDCP SN and hyper frame number (HFN) of the first PDCP SDU that the source network node 220 forwards to the target network node 240. HFN and PDCP SN are maintained after the SN assignment is handed over to the target network node 240.

At phase 2009, a random access procedure is implemented. A random access channel (RACH) is implemented at eligible time instants indicated in the time raster. When a mobile device 200 is connecting to a network, here to the target network node 240, the mobile device 200 is configured to synchronize in downlink (DL) and uplink (UL). After the mobile device 200 has synchronized to the target network node 240, it is able to perform the RRM measurements that trigger the HO. DL synchronization is obtained via synchronization channel, after successfully decoding synchronization signal block (SSB). For UL synchronization the mobile device is configured to perform RACH procedure. At phase 2009, RACH procedure enables achieving UL synchronization between the mobile device 200 and the target network node 240. The mobile device 200 is configured to synchronize to the target network node 240.

At phase 2010, the mobile device 200 is configured to send RRC reconfiguration complete message to the target network node 240. Sending is implemented at eligible times provided by the time raster. The mobile device 200 has synchronized to the target network node 240 and the RRC handover procedure has been completed.

At phase 2011, the target network node 240 is configured to send a handover success message to the source network node 220. This is configured to inform the source network node 220 on the successful handover and access of the mobile device 200 to the target network node 240. Messaging between the source network node 220 and the target network node 240 includes a HO success message, a status transfer message and a context release message. The time raster may be included in the messages between the source network node 220 and the target network node 240. The messages may include the eligible times for the HO. The messages may include the time at which HO was triggered (at phase 2007) and the time at which the HO was completed (at phase 2010). This enables providing information on trigger and completion of the HO procedure to the network nodes. This enables the source network node 220 to know, when mobile device 200 has sent the RRC reconfiguration complete message and the target network node 240 to know when the HO procedure was triggered by the source network node 220 with the transmission of the RRC reconfiguration message.

The source network node 220 is responsible for allocating DL PDCP SNs until the SN assignment is handed over to the target network node 240 and data forwarding. The source network node 220 continues to assign PDCP SNs to DL packets until it receives the handover success message from the target network node 240 and sends the SN status transfer message to the target network node 240. Upon allocation of DL PDCP SNs, the source network node 220 is configured to start scheduling DL data on the source radio link and to forward DL PDCP service data units (SDUs) along with assigned PDCP SNs to the target network node 240.

At phase 2012, in response to receiving the handover success message, the source network node 220 is configured to send a SN status transfer message for DRBs configured with DAPS, as indicated at the early status transfer message. The SN status transfer message indicates the next DL PDCP SN to allocate to a packet which does not have a PDCP SN yet. The SN status transfer message is sent to the target network node 240. The SN status transfer message may include the time raster and/or the eligible times for the HO. For example, the eligible times may comprise the time instants at which the HO was triggered and/or completed. The time instants correspond to time instants of sending the corresponding messages.

At phase 2013, a communication link enabling UL and DL communication between the mobile device 200 and the target network node 240 is established. Any UL and DL communication may be transmitted via the communication link. Communication is realized in accordance to the time raster. The mobile device 200 is configured to start transmitting UL DRB payloads to the target network node 240 at feasible times based on the time raster. The mobile device 200 is configured to wait till the next feasible UL time based on the time raster before it starts to transmit UL DRB payloads. The mobile device 200 is configured to send the RRC reconfiguration complete message at the next feasible UL time based on the time raster. This may include delaying sending the RRC reconfiguration complete message. The mobile device 200 is configured to stop sending CSI feedback to the source network node 220.

At phase 2014, a context release message relating to the mobile device 200, is sent form the target network node 240 to the source network node 220. The message may include the time raster and/or the eligible times for HO, for example the time at which the HO was triggered and the time at which the HO was completed. This enables the source network node 220 to be informed on the time of completion of the phase 2013. So, the source network node 220 has knowledge that the communication link between the mobile device 200 and the target network node 240 has been established. The message indicates that the source network node 220 may release any mobile device 220 specific context. The handover procedure is ready, and the mobile device 200 is handed over to the target network node 240.

During HO preparation, a forwarding tunnel is always established for DL. During HO execution period, the source network node and the target network node are configured to separately perform robust header compression (ROHC), ciphering and adding PDCP header. During HO execution period, the mobile device 200 continues to receive DL data from both source and target network nodes, until the connection to the source network node 220 is released by the release message received from the target network node 240 (at phase 2014). During HO execution period, the mobile device 200 DAPS PDCP is configured to maintain separate security and ROHC header decompression associated with each network node, and configured to maintain common reordering function, duplicate detection, discard function, and PDCP SDUs in-sequence delivery to upper layers.

The mobile device 200 is configured to transmit UL data to the source network node 220 until the random access (RA) procedure towards the target network node 240 has been successfully completed. After successfully completing the RA procedure, the mobile device 200 is configured to switch its UL data transmission to the target network node 240. At the same time, UL feedback from the mobile device 200 to the source network node 220 may be limited. UL feedback and data transmission to the target network node 240 may comprise UL Layer 1 (being a physical layer) channel state information (CSI) feedback, hybrid automatic repeat request (HARQ) feedback, layer 2 RLC feedback, ROHC feedback, HARQ data retransmissions, and RLC data retransmission to the source network node 220. At least some or all of the UL feedback may be configured to stop at the time when the DL DRB transmission is started from the target network node 240. The mobile device may be configured to suspend the source cell signalling radio bearers (SRBs) for the source network node, to stop sending and receiving RRC control plane signalling toward the source network node and to establish SRBs for the target network node.

In case DAPS HO to the target cell fails and if the source cell link is available, the mobile device is configured to revert back to the source cell configuration and activate the source cell SRBs for control plane signalling.

During handover execution period, the mobile device 200 is configured to maintain separate security context and ROHC context for UL transmissions towards the source and target network nodes 220, 240. The mobile device 200 is configured to maintain common UL PDCP SN allocation. The source and target network nodes 220, 240 are configured to maintain their own security and ROHC contexts in order to process UL data received from the mobile device 200.

Prior to a HO, a mobile device is connected to a source network node. The source network node is aware of traffic characteristics and quality of service (QoS) constraints associated thereto. The source network node is configured to monitor when payloads, for example of XR traffic, are received at the RAN. The network nodes receive traffic information from a core network. Based on the received XR payloads and/or the information received from the 5G core network, windows of desirable interruption times may be determined. Desirable interruption times are selected to minimize impact on the performance and QoS of the network service or communication with a mobile device.

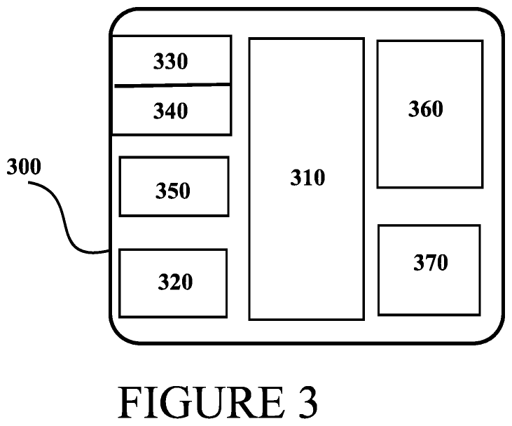

FIG. 3 shows, by way of example, a block diagram of an apparatus. An apparatus being capable of implementing a handover in a communication network. Illustrated is a device 300, which may comprise, for example, a mobile communication device such as UE 100, 102 of FIG. 1 or mobile 200 of FIG. 2. A device 300 comprises a processor 310, which may comprise, for example, a single- or multi-core processor wherein a single-core processor comprises one processing core and a multi-core processor comprises more than one processing core. The processor 310 may comprise, in general, a control device. The processor 310 may be a control device. The processor 310 may comprise more than one processor unit or processing core. A processing core may comprise, for example, a Cortex-A8 processing core manufactured by ARM Holdings or a Steamroller processing core designed by Advanced Micro Devices Corporation. The processor 310 may comprise at least one Qualcomm Snapdragon and/or Intel Atom processor. The processor 310 may comprise at least one application-specific integrated circuit, ASIC. The processor 310 may comprise at least one field-programmable gate array, FPGA. The processor 310 may be means for performing method steps in device 300. The processor 310 may be configured, at least in part by computer instructions, to perform actions.

A processor may comprise circuitry, or be constituted as circuitry or circuitries, the circuitry or circuitries being configured to perform phases of methods in accordance with example embodiments described herein. As used in this application, the term “circuitry” may refer to one or more or all of the following: (a) hardware-only circuit implementations, such as implementations in only analog and/or digital circuitry, and (b) combinations of hardware circuits and software, such as, as applicable: (i) a combination of analog and/or digital hardware circuit(s) with software/firmware and (ii) any portions of hardware processor(s) with software (including digital signal processor(s)), software, and memory(ies) that work together to cause an apparatus, such as a mobile phone or server, to perform various functions) and (c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

A device 300 may comprise a memory 320. The memory 320 may comprise random-access memory and/or permanent memory. The memory 320 may comprise at least one RAM chip. The memory 320 may comprise solid-state, magnetic, optical and/or holographic memory, for example. The memory 320 may be at least in part accessible to the processor 310. The memory 320 may be at least in part comprised in processor 310. The memory 320 may be means for storing information. The memory 320 may comprise computer instructions that the processor 310 is configured to execute. When computer instructions configured to cause a processor 310 to perform certain actions are stored in a memory 320, and a device 300 overall is configured to run under the direction of the processor 310 using computer instructions from the memory 320, the processor 310 and/or its at least one processing core may be considered to be configured to perform said certain actions. The memory 320 may be at least in part external to the device 300 and accessible to the device 300.

The device 300 may comprise a transmitter 330. The device 300 may comprise a receiver 340. The transmitter 330 and the receiver 340 may be configured to transmit and receive, respectively, information in accordance with at least one cellular or non-cellular standard. The transmitter 330 may comprise more than one transmitter unit. The receiver 340 may comprise more than one receiver unit. The transmitter 330 and/or the receiver 340 may be configured to operate in accordance with global system for mobile communication, GSM, wideband code division multiple access, WCDMA, 5G, long term evolution, LTE, IS-95, wireless local area network, WLAN, Ethernet and/or worldwide interoperability for microwave access, WiMAX, standards, for example.

The device 300 may comprise a near-field communication, NFC, transceiver 350. The NFC transceiver 350 may support at least one NFC technology, such as NFC, Bluetooth, Wibree or similar technologies.

The device 300 may comprise a user interface, UI, 360. The UI 360 may comprise at least one of a display, a keyboard, a touchscreen, a vibrator arranged to signal to a user by causing the device 300 to vibrate, a speaker and a microphone. A user may be able to operate the device 300 via the UI 360, for example to accept incoming telephone calls, to originate telephone calls or video calls, to browse the Internet, to manage digital files stored in the memory 320 or on a cloud accessible via the transmitter 330 and the receiver 340, or via the NFC transceiver 350, and/or to play games.

The device 300 may comprise or be arranged to accept a user identity module 370. The user identity module 370 may comprise, for example, a subscriber identity module, SIM, card installable in the device 300. A user identity module 370 may comprise information identifying a subscription of a user of device 300. A user identity module 370 may comprise cryptographic information usable to verify the identity of a user of device 300 and/or to facilitate encryption of communicated information and billing of the user of the device 300 for communication effected via the device 300.

A processor 310 may be furnished with a transmitter arranged to output information from the processor 310, via electrical leads internal to the device 300, to other devices or device blocks comprised in the device 300. Such a transmitter may comprise a serial bus transmitter arranged to, for example, output information via at least one electrical lead to a memory 320 for storage therein. Alternatively to a serial bus, the transmitter may comprise a parallel bus transmitter. Likewise, the processor 310 may comprise a receiver arranged to receive information in the processor 310, via electrical leads internal to the device 300, from other devices comprised in the device 300. Such a receiver may comprise a serial bus receiver arranged to, for example, receive information via at least one electrical lead from the receiver 340 for processing in the processor 310. Alternatively to a serial bus, the receiver may comprise a parallel bus receiver.

A device 300 may comprise further devices not illustrated in FIG. 3. For example, where the device 300 comprises a smartphone, it may comprise at least one digital camera. Some devices 300 may comprise a back-facing camera and a front-facing camera, wherein the back-facing camera may be intended for digital photography and the front-facing camera for video telephony. The device 300 may comprise a fingerprint sensor arranged to authenticate, at least in part, a user of the device 300. In some example embodiments, the device 300 lacks at least one device block described above. For example, some devices 300 may lack a NFC transceiver 350 and/or a user identity module 370.

A processor 310, a memory 320, a transmitter 330, a receiver 340, a NFC transceiver 350, a UI 360 and/or a user identity module 370 may be interconnected by electrical leads internal to a device 300 in a multitude of different ways. For example, each of the aforementioned device blocks may be separately connected to a master bus internal to the device 300, to allow for the device blocks to exchange information. However, as the skilled person will appreciate, this is only one example and depending on the embodiment various ways of interconnecting at least two of the aforementioned device blocks may be selected.

The time raster is exchanged between source and target cells and between the source cell and the mobile device. Determining a time raster may be based on monitoring communication traffic by a network node and/or received traffic information form 5G core network. The determination may take into account network quality of service. UL and DL payloads at RAN may be monitored in order to find out (time-) critical payloads, which may differ between UL and DL. The payloads may relate to a communication or a service of the mobile device. Based on identified critical payloads, timing of those are marked as non-eligible for any other transmission/reception, and reserved for the identified time-critical payloads. When times of critical payloads are identified, times between the critical payloads are marked as eligible for other transmission/reception. The eligible time refers to a preferred or allowed time for HO signalling and messaging, for example. Non-eligible times refer to prohibited or non-preferred times or time instants, which are not to be used for any other transmission or reception. Use of non-eligible times for HO messaging is avoided or blocked. The time raster may be in various forms, as expressed in the following by way of an example. However, different implementations and examples are possible.

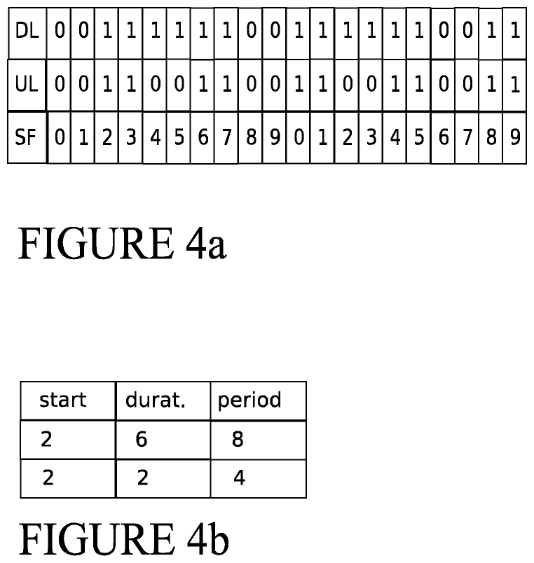

FIG. 4a shows, by way of an example, a time raster implementation. The time raster is expressed in FIG. 4a as two vectors, UL and DL with reference to the subframe (SF) vector. The SF illustrates corresponding SF index. The UL and DL vectors comprise Boolean elements, 1 or 0. The element 0 may be configured to indicate a non-eligible time for switching and the element 1 may be configured to indicate an eligible time for switching. The two vectors may be used with a frequency division duplex (FDD) technique. With a time division duplex (TDD) technique a single vector is used. The time resolution of the vectors may be on slot, sub-slot or sub-frame level. The time resolution used in the vector may be referred as times or time instants. As shown in FIG. 4a, UL and DL vectors differ from one another. The UL and DL vectors may be based on monitored traffic preceding a HO decision. As an example, XR payload may be transmitted in DL approximately every 16 ms (60 frames per second, fps), plus/minus a few ms due to jitter variations. XR payload transmitted in UL may comprise pose/control payloads approximately every 4 ms. Accordingly, interruptions defined with the time raster shall be timed to happen in between of the mentioned time-critical XR payloads.

Alternatively, a time raster may comprise a specific time, at which the DL and UL switching shall happen. The time may be expressed with aid of a system frame number (SFN) and number of slots, sub-slots or sub-frames in the SFN. A source network node may be configured to determine the specific times. The determination may comprise taking into account possible anticipated times at different phases, for example sum times for sending a RRC reconfiguration message, a mobile device processing, time for RA, and other.

FIG. 4b shows, by way of an example, another time raster implementation. In this example start, duration and periodicity of eligible times are determined. Start refers to starting sub-frame, sub-slots or slot of a sequence of eligible times. Duration refers to the number of consecutive eligible times defined in terms of sub-frames, sub-slots or slots. Periodicity refers to periodicity of the sequence of eligible or non-eligible times. The identification of the eligible and/or non-eligible times may be computed by a network device using the start, duration and periodicity of the times. This may be expressed in form of an executable code or a pseudo code, for example as follows:
If (SF % Period (DL)==0) then start a new HO eligibility period for DL
If((SF % Period (DL))>=Start) &&
(SF % Period (DL))<Start (DL)+Duration (DL)) then DL is HO eligible

In the previous, end of eligibility is determined as:
(SF % Period (DL))<Start (DL)+Duration (DL) OR
(SF % Period (DL))<=Start (DL)+Duration (DL)−1)

As yet another embodiment, the time raster may be expressed as a specific time window in the format of a clock information, for example UTC time or UTC time plus a duration information to define the time window.

The time raster enables providing reliability to communication network performance and control to interruptions. This provides enhancements to the previously experienced interruptions. Previously, time from the decision of the HO by a source cell to the implementation by UE starting to send data to target cell has not been fully known. This included time from sending a RRC reconfiguration command form the source cell until correct reception and decoding at the UE, which is subject to hybrid automatic repeat request (HARQ), and potential variations of UE processing times, of which only maximum UE processing times are specified. Further, exact latency between source and target cells may not have been fully known. The time for the UE to complete the random access (RA) procedure towards the target cell has been subject to variations. This may depend on whether the first RA request is successful and different types of RA procedures, like a contention free random access (CFRA) or a contention based random access (CBRA). Previously, interruption times during a DAPS HO for DL bearers corresponded to interruption times at the source cell and at the target cell. For intra-frequency DAPS HO, the interruption time at the source cell may have been 1 ms and the interruption time at the target cell may have been be 1 ms. In such case it was assumed the same bandwidth path (BWP) for the source and target cells. Previously, interruption times during a DAPS HO for UL in a contention based random access (CBRA) comprise UL switch including sending new UL PDCP SDU and the non-acknowledged PDCP PDUs to the target cell, which occurs after MAC coverage enhancement (CE) contention resolution is received. Previously, the target cell being configured to forward UL packets to UPF after two handover success messages and SN status transfer message have been sent. This may have taken approximately 10 ms, and with interruption time of the target cell, ended up to approximately 11 ms. In a contention free random access (CFRA) UL switch is performed in response to receiving a random access response (RAR). Additional delay for sending RRC reconfiguration complete may be 8 ms. Total interruption may end up to approximately 19 ms. Further, the time for the UE to send the RRC reconfiguration complete message until the message is successfully decoded at the target cell network node is subject to timing variations, for example due to UL scheduling of the UE, potential HARQ communications. At least some or all previously caused unreliability or latencies may be reduced or avoided with aid a time raster as introduced.

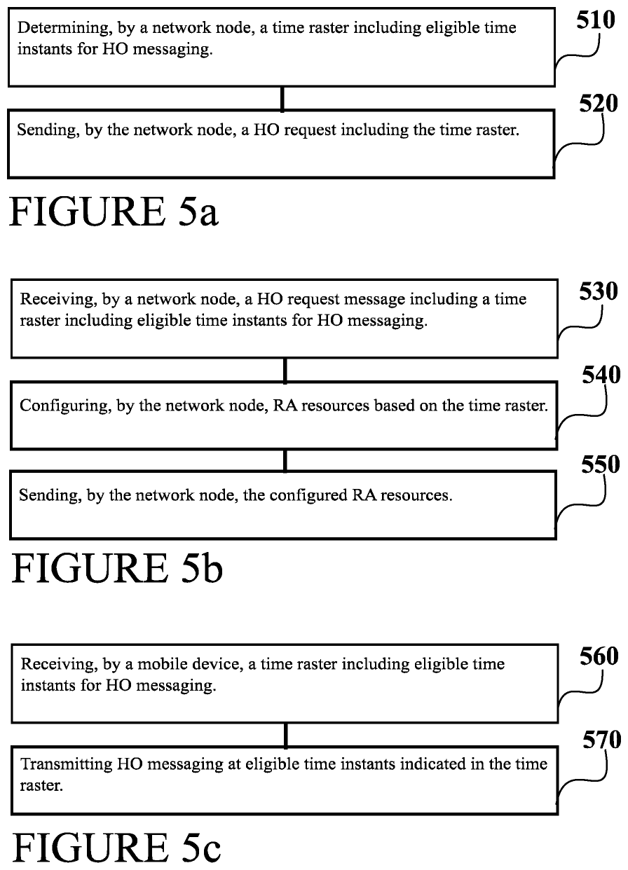

FIG. 5a shows, by way of an example, a flow graph of a method for a source network node. The phases of the illustrated method may be performed in a network node 220. The method comprises determining by a network node, a time raster indicating eligible times for HO messaging 510. The determination is done with or after a decision to handover a mobile device is made. Preceding this phase, the network node has performed monitoring XR traffic between the mobile device and the network node. The monitoring may comprise monitoring RAN, arrival times at RAN, detecting time-critical payload of XR both UL and DL. In addition, or alternatively, the network node may receive traffic information from core network entities. Based on the monitored information and/or received traffic information, and possibly taking into account XR QoS constraints, time-critical XR payload transmissions and timing of such are identified. Time-critical XR payload times are to be avoided. Thus, based on such, eligible times and non-eligible times for HO transmissions/receptions are identified. The information may be realized using selected expression of a time raster indicating eligible times for HO messaging. The method comprises sending a HO request including the time raster 520. The method may further comprise receiving RA configuration based on the time raster, from a target network node. The method may further comprise triggering a HO. This may comprise sending RRC reconfiguration message, including the time raster information, to a mobile device. In addition, the method may comprise sending a SN status transfer message in response to receiving a HO success message. The HO success message is received from a target network node. The SN status transfer message is sent to a target network node.

FIG. 5b shows, by way of an example, a flow graph of a method for a target network node. The phases of the illustrated method may be performed in a network node 240. The method comprises receiving, by a network node, a HO request message including a time raster indicating eligible times for HO messaging 530. In response to receiving the HO request, the method comprises configuring, by the network node, RA resources based on the time raster 540. The RA resources are configured for a mobile device HO messaging. The method comprises sending the configured RA resources 550. The method may further comprise sending a HO success message at an eligible time as indicated in the time raster, in response to receiving an RRC reconfiguration complete message. The HO success message is sent to a source network node. The RRC reconfiguration complete message is received form a mobile device. In addition, the method may comprise sending a context release message to a source network node.

FIG. 5c shows, by way of an example, a flow graph of a method for a mobile device. The phases of the illustrated method may be performed in a mobile device 200, an auxiliary device or a personal computer, for example, or in a control device configured to control the functioning thereof, when installed therein. The method may comprise sending a measurement report to a network node. The method comprises receiving, by a mobile device, a time raster indicating eligible times for HO messaging 560. The method comprises performing RACH procedure, which may include implementing UL synchronization and RRC connection to a target network node, at eligible times indicated in the time raster. The method may further comprise sending a RRC reconfiguration complete message at an eligible time indicated in the time raster. The RRC reconfiguration complete message is sent to a target network node.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. An apparatus for a network node, the apparatus comprising:
at least one processor; and
at least one memory including computer program code, the at least one memory and the computer program code configured to, with the at least one processor, cause the apparatus at least to perform:
making a decision on a handover; (HO);
determining a time raster indicating eligible time instants for HO messaging during a network communication; wherein the eligible time instants are based on at least one of: a radio access network (RAN) traffic and a core network (CN); and
sending a HO request message including the time raster.

2. The apparatus according to claim 1, caused to perform at least one of:
monitoring the traffic payloads;
identifying time-critical payloads; or
receiving the traffic quality information.

3. The apparatus according to claim 1, wherein the time raster is included in the HO request message as an information element.

4. The apparatus according to claim 1, caused to perform: receiving a HO request acknowledge message including radio access (RA) resources based on the time raster information, which RA resources are configured for the HO.

5. The apparatus according to claim 1, caused to perform: triggering the HO and means for sending a radio resource control (RRC) reconfiguration message including the time raster.

6. The apparatus according to claim 1, caused to perform:
receiving a HO success message including the time raster and/or the time instant of the completion of the HO; and
sending a sequence number (SN) status transfer message, in response to receiving the HO success message.

7. An apparatus for a network node, the apparatus comprising:
at least one processor; and
at least one memory including computer program code, the at least one memory and the computer program code configured to, with the at least one processor, cause the apparatus at least to perform:
receiving a handover (HO) request message including a time raster indicating eligible time instants for HO messaging during a network communication; wherein the eligible time instants are based on at least one of: a radio access network (RAN) traffic and a core network (CN); and
configuring random access (RA) resources for the HO based on the received time raster.

8. The apparatus according to claim 7, caused to perform:
means for sending a HO success message, in response to receiving a radio resource control (RRC) reconfiguration complete message, wherein the HO success message includes the time raster and/or the time instant of the transmission of the received RRC reconfiguration complete message.

9. The apparatus according to claim 7, caused to perform:
sending a context release message including at least one of: the time raster, the time instant of the trigger of the HO, and the time instant of the completion of the HO.

10. An apparatus for a mobile device, the apparatus comprising:
at least one processor; and
at least one memory including computer program code, the at least one memory and the computer program code configured to, with the at least one processor, cause the apparatus at least to perform:
receiving a radio resource control (RRC) reconfiguration message including a time raster indicating eligible time instants for handover messaging during a network communication; wherein the eligible time instants are based on a radio access network (RAN) traffic and/or a core network (CN);
performing random access channel (RACH) procedure at one or more eligible time instants indicated in the time raster;
and
optionally sending a RRC reconfiguration complete message at one or more eligible time instants indicated in the time raster.

11. The apparatus according to claim 1, wherein the network communication comprises at least one of the following:
a periodic or a quasiperiodic network communication, or
XR communication.

12-24. (canceled)

25. The apparatus according to claim 1, wherein the time raster is at least one of the following:
configured to indicate eligible time instants to switch uplink (UL) and downlink (DL) data radio bearers (DRBs) for the HO, the eligible time instants being at least one of the following:
based at least partly on network quality of service (QOS) constraints or quality of service identifier (5QI) values,
set in between the identified time-critical payloads of the RAN traffic, or
set in between critical CN traffic,
expressed in at least one of the following forms: a vector, two separate vectors for UL and DL, an executable code, a pseudo code, a time and duration information, a specific time information, and a time window, or
configured to indicate eligible and non-eligible time instants, optionally in form of at least one of: frames, sub-frames, slots, sub-slots, frame numbers, numerical information, code information, and clock information.

26. The apparatus according to claim 1, wherein the HO comprises a dual active protocol stack (DAPS) HO.

27. The apparatus according to claim 7, wherein the network communication comprises at least one of the following:
a periodic or a quasiperiodic network communication, or
XR communication.

28. The apparatus according to claim 7, wherein the time raster is at least one of the following:
configured to indicate eligible time instants to switch uplink (UL) and downlink (DL) data radio bearers (DRBs) for the HO, the eligible time instants being at least one of the following:
based at least partly on network quality of service (QOS) constraints or quality of service identifier (5QI) values,
set in between the identified time-critical payloads of the RAN traffic, or
set in between critical CN traffic;
expressed in at least one of the following forms: a vector, two separate vectors for UL and DL, an executable code, a pseudo code, a time and duration information, a specific time information, and a time window; or
configured to indicate eligible and non-eligible time instants, optionally in form of at least one of: frames, sub-frames, slots, sub-slots, frame numbers, numerical information, code information, and clock information.

29. The apparatus according to claim 7, wherein the HO comprises a dual active protocol stack (DAPS) HO.

30. The apparatus according to claim 10, wherein the network communication comprises at least one of the following:
a periodic or a quasiperiodic network communication, or
XR communication.

31. The apparatus according to claim 10, wherein the time raster is at least one of the following:
configured to indicate eligible time instants to switch uplink (UL) and downlink (DL) data radio bearers (DRBs) for the HO, the eligible time instants being at least one of the following:
based at least partly on network quality of service (QOS) constraints or quality of service identifier (5QI) values,
set in between the identified time-critical payloads of the RAN traffic, or
set in between critical CN traffic,
expressed in at least one of the following forms: a vector, two separate vectors for UL and DL, an executable code, a pseudo code, a time and duration information, a specific time information, and a time window, or
configured to indicate eligible and non-eligible time instants, optionally in form of at least one of: frames, sub-frames, slots, sub-slots, frame numbers, numerical information, code information, and clock information.

32. The apparatus according to claim 10, wherein the HO comprises a dual active protocol stack (DAPS) HO.
